(19) United States
(12) Patent Application Publication
(10) Pub. No.: US 2025/0383441 A1
(43) Pub. Date: Dec. 18, 2025

(54) WARNING APPARATUS AND WARNING METHOD

(71) Applicants: TOYOTA JIDOSHA KABUSHIKI KAISHA, Aichi-ken (JP); DENSO CORPORATION, Aichi-pref (JP)

(72) Inventors: Issei MATSUNAGA, Nagoya-shi (JP); Masaho ISHIDA, Toyota-shi (JP); Hiroaki IIDA, Hashima-shi (JP)

(21) Appl. No.: 19/193,979

(22) Filed: Apr. 30, 2025

(30) Foreign Application Priority Data
Jun. 13, 2024 (JP) 2024-095950

(51) Int. Cl. G01S 13/86; G01S 13/04; G01S 13/931; G01S 15/08; G01S 15/931; G08G 1/16

(52) U.S. Cl. CPC G01S 13/862; G01S 13/04; G01S 13/931; G01S 15/08; G01S 15/931; G08G 1/16

(57) ABSTRACT

A warning apparatus for warning an occupant of a vehicle includes: a mobile object detection section that detects a mobile object behind the vehicle based on output data of sensors; a stationary object detection section that detects a stationary object behind the vehicle based on output data of sensors; and a warning section that warns the occupant when the mobile object is predicted to approach and arrive at a door of the vehicle. The warning section refrains from issuing the warning when the stationary object is detected to be located ahead of the mobile object even if the mobile object is predicted to approach and arrive at the door, and does not refrain from issuing the warning when the stationary object is another vehicle including a projection that projects in a vehicle width direction even when the stationary object is detected to be located ahead of the mobile object.

### CROSS-REFERENCE TO RELATED APPLICATION

This application claims priority to Japanese Patent Application No. 2024-095950 filed on Jun. 13, 2024, incorporated herein by reference in its entirety.

### BACKGROUND

### 1. Technical Field

The present disclosure relates to a warning apparatus and a warning method.

### 2. Description of Related Art

Apparatuses have been known that detect other vehicles around an own vehicle and notify an occupant that another detected vehicle is approaching in a case where the other vehicle is approaching the own vehicle (see Japanese Unexamined Patent Application Publication No. 2023-163805 (JP 2023-163805 A) and Japanese Unexamined Patent Application Publication No. 2016-045838 A (JP 2016-045838 A)). In particular, the apparatus described in JP 2023-163805 A notifies the occupant when a sensor that detects an object located behind the own vehicle detects another vehicle approaching the own vehicle.

### SUMMARY

The presence of a stationary object such as a parked vehicle behind a vehicle, however, causes a sensor to detect an object in error in some cases because of reflection by the stationary object. It is thus conceivable in the case to refrain from notifying an occupant along with the detection of the object. In such a case, the occupant may be, however, prevented from being notified, for example, even in a case where an object that is actually present is detected through the outer mirror of the parked vehicle.

In view of the problem, an object of the present disclosure is to restrain issuance of a notification to an occupant from being prevented in error.

The gist of the present disclosure is as follows.
(1) A warning apparatus configured to warn an occupant of a vehicle including: a mobile object detection section configured to detect a mobile object behind the vehicle based on output data of a sensor; a stationary object detection section configured to detect a stationary object behind the vehicle based on output data of a sensor; and a warning section configured to warn the occupant of the vehicle in a case where the mobile object is predicted to approach the vehicle and arrive at a door of the vehicle. The warning section is configured to refrain from issuing the warning when the stationary object is detected to be located ahead of the mobile object even in the case where the mobile object is predicted to approach the vehicle and arrive at the door of the vehicle, and is configured not to refrain from issuing the warning when the stationary object is another vehicle that includes a projection that projects in a vehicle width direction even when the stationary object is detected to be located ahead of the mobile object.
(2) A warning method for warning an occupant of a vehicle including: detecting a mobile object behind the vehicle based on output data of a sensor; detecting a stationary object behind the vehicle based on output data of a sensor; and warning the occupant of the vehicle in a case where the mobile object is predicted to approach the vehicle and arrive at a door of the vehicle. The warning is prevented from being issued when the stationary object is detected to be located ahead of the mobile object even in the case where the mobile object is predicted to approach the vehicle and arrive at the door of the vehicle, and the warning is not prevented from being issued when the stationary object is another vehicle that includes a projection that projects in a vehicle width direction even when the stationary object is detected to be located ahead of the mobile object.

According to the present disclosure, issuance of a notification to an occupant is restrained from being prevented in error.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram schematically illustrating a warning system in which a warning apparatus is implemented;

FIG. 2 is a diagram illustrating the disposition of sensors provided on a vehicle;

FIG. 3 is a functional block diagram of a processor of an ECU;

FIG. 4A is a diagram illustrating an example of a case where another vehicle is stopped behind a stopped vehicle and a motorcycle is traveling around the vehicle;

FIG. 4B is a diagram illustrating an example of a case where the other vehicle is stopped behind the stopped vehicle and the motorcycle is traveling around the vehicle;

FIG. 5 is a flowchart illustrating a flow of warning processing;

FIG. 6 is a diagram illustrating another vehicle located behind a vehicle;

FIG. 7A is a diagram similar to FIG. 6 and illustrates another vehicle located behind the vehicle; and

FIG. 7B is a diagram similar to FIG. 6 and illustrates the other vehicle located behind the vehicle.

### DETAILED DESCRIPTION OF EMBODIMENTS

Hereinafter, an embodiment will be described in detail with reference to the drawings. It is to be noted that similar components will be denoted by the same reference signs in the following description.

### Configuration of Warning System

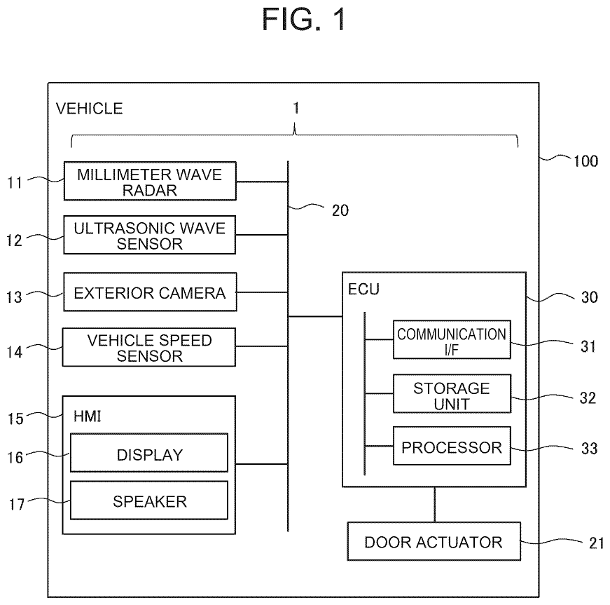

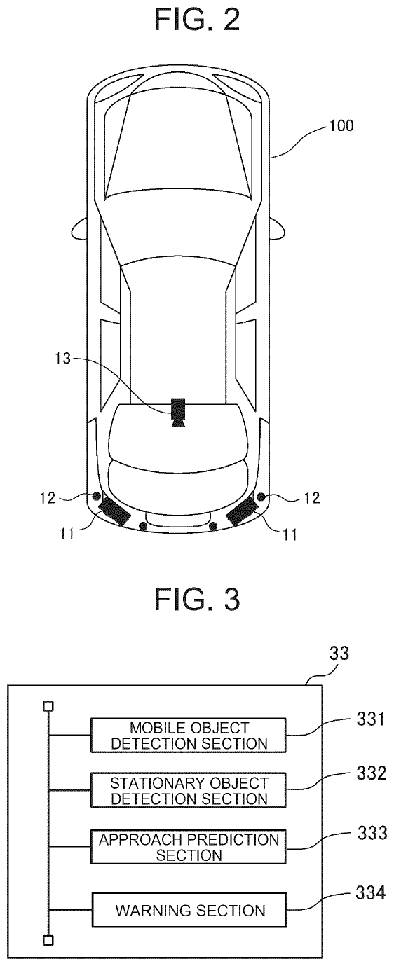

The configuration of a warning system 1 on which a warning apparatus is mounted will be described with reference to FIG. 1 and FIG. 2. FIG. 1 is a configuration diagram schematically illustrating a warning system 1 in which a warning apparatus according to one embodiment is implemented. FIG. 2 is a diagram illustrating the disposition of sensors provided on a vehicle 100. The warning system 1 is mounted on the vehicle 100 and warns an occupant of the vehicle 100. In particular, in a case where a mobile object is predicted to approach the vehicle 100 and arrive at a door of the vehicle 100, the warning system 1 warns an occupant of the vehicle 100.

As illustrated in FIG. 1, the warning system 1 includes a millimeter wave radar 11, an ultrasonic wave sensor 12, an exterior camera 13, a vehicle speed sensor 14, a human machine interface (HMI) 15, a door actuator 21, and an electronic control unit (referred to as an “ECU” below) 30. The millimeter wave radar 11, the ultrasonic wave sensor 12, the exterior camera 13, the vehicle speed sensor 14, the HMI 15, and the ECU 30 are communicably connected, for example, through an in-vehicle network 20. The in-vehicle network 20 is a network, for example, compliant with a standard such as a controller area network (CAN). In addition, the ECU 30 is connected to the door actuator 21 through a signal line.

It is to be noted that the ECU 30 is formed as a different entity from the millimeter wave radar 11, the ultrasonic wave sensor 12, and the exterior camera 13 in the example illustrated in FIG. 1. At least any one of the millimeter wave radar 11, the ultrasonic wave sensor 12, and the exterior camera 13 may be, however, incorporated into the ECU 30 and formed to be integrated with the ECU 30. In addition, in the example illustrated in FIG. 1, the ECU 30 is formed as a different entity from a speaker 17. The speaker 17 may be, however, incorporated into the ECU 30 and formed to be integrated with the ECU 30.

The millimeter wave radar 11 is an example of a sensor that detects the distance to a target (object) around the vehicle 100. In addition, the millimeter wave radar 11 is also capable of detecting the direction with respect to the vehicle 100 in which a target around the vehicle 100 is located and the speed of the target relative to the vehicle 100. As illustrated in FIG. 2, in the present embodiment, the millimeter wave radars 11 are provided at the right rear and left rear of the vehicle 100 one by one. The respective millimeter wave radars 11 detect an object located behind and to the right of the vehicle 100 and an object located behind and to the left of the vehicle 100.

Each of the millimeter wave radars 11 emits radio waves from a transmitting antenna and receives reflection waves with a receiving antenna. The millimeter wave radar 11 then measures the distance to a target based on the time from the emission of the radio waves from the transmitting antenna to the reception of the reflection waves. In addition, the millimeter wave radar 11 measures the direction of the target with respect to the millimeter wave radar 11 based on a deviation in the reception of reflection waves between a plurality of receiving antennas disposed side by side. The millimeter wave radar 11 mixes radio waves emitted from a transmitting antenna and reflection waves received with a receiving antenna and then performs signal processing to generate output data regarding positional information about the target and output the output data to the ECU 30.

The ultrasonic wave sensor 12 is an example of a sensor that detects the distance to a target (object) around the vehicle 100. In addition, the ultrasonic wave sensor 12 is also capable of detecting the direction with respect to the vehicle 100 in which a target around the vehicle 100 is located and the speed of the target relative to the vehicle 100. The ultrasonic wave sensor 12 uses ultrasonic waves instead of millimeter waves to generate output data regarding positional information about the target and output the output data to the ECU 30 as with the millimeter wave radar 11.

It is to be noted that the ultrasonic wave sensor 12 has a narrow detection range. As illustrated in FIG. 2, the ultrasonic wave sensors 12 are thus provided on the vehicle 100 at shorter intervals than the interval between the millimeter wave radars 11. In the present embodiment, four ultrasonic wave sensors 12 are disposed at the rear of the vehicle 100 in the vehicle width direction of the vehicle 100 at intervals. In addition, the ultrasonic wave sensors 12 are disposed lower than the millimeter wave radars 11. Each of 10 the ultrasonic wave sensors 12 therefore detects the distance to a target in a lower region in the vertical direction than the millimeter wave radars 11.

In the present embodiment, the millimeter wave radars 11 and the ultrasonic wave sensors 12 are each provided as sensors that detect the distance to a target around the vehicle 100. Another sensor including another radar such as a laser radar (LiDAR) may be, however, used as a sensor. The laser radar is a sensor that measures reflection light for pulsed radiated laser light and measures the position of a target within the measurement range.

The exterior camera 13 is an example of a sensor that images the region around the vehicle 100. In the present embodiment, as illustrated in FIG. 2, the exterior camera 13 is disposed at the rear of the vehicle 100 (inside the rear window) and images the region behind the vehicle 100. The exterior camera 13 is, for example, a CMOS camera or a CCD camera having sensitivity to visible light. The exterior camera 13 images the rear region of the vehicle 100 in each predetermined imaging cycle and generates image data (output data) showing the rear region. It is to be noted that the exterior camera 13 may be a 25 monocular camera or a stereo camera. In addition, the exterior camera 13 does not have to be provided in the warning system 1.

The vehicle speed sensor 14 is an example of a sensor that detects the speed of the vehicle 100. The vehicle speed sensor 14 detects, for example, the rotation speed of a wheel of the vehicle 100. The vehicle speed sensor 14 generates output data regarding the speed of the vehicle 100 and outputs the output data to the ECU 30.

The HMI 15 is an interface that receives and outputs information between a driver or a passenger, and the warning system 1. The HMI 15 includes an information providing device that provides various kinds of information to a driver or a passenger and an input device that allows a driver or a passenger to perform an input operation.

Specifically, the HMI 15 includes, as the information providing device, a display 16 that displays character information or image information. The display 16 is an example of a display device that displays an image. The display 16 is a display device of any system such as a liquid crystal display or an organic EL display. The display 16 is disposed, for example, at an instrument panel, a meter panel, or the like of the vehicle 100. The display 16 receives an image signal from the ECU 30 through the in-vehicle network 20 and displays an image in accordance with the image signal.

In addition, the HMI 15 includes the speaker 17 as the information providing device. The speaker 17 is an example of a device that outputs sound. The speaker 17 receives an audio signal from the ECU 30 through the in-vehicle network 20 and outputs sound in accordance with the audio signal. It is to be noted that the HMI 15 may include a device (e.g., a vibration device or the like) other than the display 16 and the speaker 17 as the information providing device. The device provides various kinds of information to a driver or a passenger.

The door actuator 21 controls the state of a door of the vehicle 100. The door actuator 21 is provided at each of the doors and controls the state of each door in accordance with a control signal from the ECU 30. The control signal is transmitted through a signal line. The door actuator 21 controls, for example, the lock of a door of the vehicle 100.

### Configuration of Warning Apparatus

The ECU 30 functions as a warning apparatus that warns an occupant of the vehicle 100. In addition, the ECU 30 executes a warning method for warning an occupant of the vehicle 100. As illustrated in FIG. 1, the ECU 30 includes a communication interface 31, a storage unit 32, and a processor 33.

The communication interface 31 is a circuit that connects the ECU 30 to the in-vehicle network 20.

The storage unit 32 is an example of a non-transitory storage medium that stores data. The storage unit 32 includes, for example, at least any one of a volatile semiconductor memory, a non-volatile semiconductor memory, a hard disk drive (HDD), and a solid state drive (SSD). The storage unit 32 stores a computer program that is executed by the processor 33 of the ECU 30. In addition, the storage unit 32 stores data to be used in the computer program that is executed by the processor 33 such as pieces of data transmitted from the various sensors.

The processor 33 includes one or more central processing units (CPUs) and a peripheral circuit thereof. The processor 33 may further include another arithmetic circuit such as a logical operation unit or a numeric operation unit. The processor 33 executes various kinds of processing based on the computer program stored in the storage unit 32.

FIG. 3 is a functional block diagram of the processor 33 of the ECU 30. As illustrated in FIG. 3, the processor 33 includes a mobile object detection section 331, a stationary object detection section 332, an approach prediction section 333, and a warning section 334. Each of the sections included in the processor 33 is a functional module achieved, for example, by a computer program that comes into operation on the processor 33. Alternatively, each of the sections included in the processor 33 may be implemented in the ECU 30 as an independent integrated circuit, a microprocessor, or firmware.

The mobile object detection section 331 detects a mobile object behind the vehicle 100 based on output data of a sensor. In the present embodiment, the mobile object detection section 331 detects a mobile object based on output data of the millimeter wave radars 11 or the ultrasonic wave sensors 12. In addition, the mobile object detection section 331 may detect a mobile object based on output data of the exterior camera 13.

Specifically, when it is detected based on time-series output data of the millimeter wave radars 11 or the ultrasonic wave sensors 12 that the distance or the direction of a target around the vehicle 100 changes, the mobile object detection section 331 detects the target as a mobile object. For example, the mobile object detection section 331 outputs positional information (the position, the speed, or the like relative to the vehicle 100) about a mobile object around the vehicle 100 by sequentially inputting pieces of time-series output data of the millimeter wave radars 11 or the ultrasonic wave sensors 12 to a discriminator. The discriminator is, for example, a regression neural network (RNN) that sequentially receives the pieces of time-series data.

In addition, the mobile object detection section 331 may detect an object around the vehicle 100 based on output data of the exterior camera 13 and identify the type of mobile object detected based on output data of the millimeter wave radars 11 or the ultrasonic wave sensors 12. For example, the mobile object detection section 331 sequentially inputs the pieces of data of images captured by the exterior camera 13 to a discriminator to detect the type (e.g., a pedestrian, a bicycle, a motorcycle, an automobile, or the like) of object appearing in each of the images and the region in the image in which the object appears. The discriminator is, for example, a convolutional neural network (CNN) including a plurality of convolutional layers connected in series from the input side to the output side. In addition, the mobile object detection section 331 identifies the type of each mobile object based on the region of the object appearing in the image of each piece of image data and positional information about the mobile object detected based on data received from the millimeter wave radars 11 or the ultrasonic wave sensors 12. The mobile object detection section 331 thus outputs the type of each mobile object around the vehicle 100 and the positional information about the mobile object.

Additionally, in the present embodiment, the mobile object detection section 331 detects a mobile object around the vehicle 100 based on the output data of the exterior camera 13 in addition to the pieces of output data of the millimeter wave radars 11 and the ultrasonic wave sensors 12. The mobile object detection section 331 may, however, detect a mobile object based on the output data of the millimeter wave radars 11 alone or the output data of the ultrasonic wave sensors 12 alone or may detect a mobile object based on the output data of the exterior camera 13 alone.

The stationary object detection section 332 detects a stationary object behind the vehicle 100 based on output data of a sensor. In the present embodiment, the stationary object detection section 332 detects a stationary object based on output data of the exterior camera 13. In addition, the stationary object detection section 332 may detect a stationary object based on output data of the millimeter wave radars 11 or the ultrasonic wave sensors 12.

The stationary object detection section 332 detects an object around the vehicle 100 based on output data of the exterior camera 13 as with the mobile object detection section 331. The stationary object detection section 332, for example, sequentially inputs the pieces of data of images captured by the exterior camera 13 to a discriminator to detect the type of object appearing in each of the images and the shape thereof (e.g., in a case where a vehicle appears in the image, the position, size, or the like of an outer mirror in addition to the shape of the vehicle body). The discriminator is, for example, a convolutional neural network (CNN).

In addition, the stationary object detection section 332 may determine based on time-series output data of the millimeter wave radars 11 or the ultrasonic wave sensors 12 whether or not an object (stationary object) around the vehicle 100 stands still, and may output positional information about the object in a case where the object stands still. The stationary object detection section 332 may thus output positional information about a stationary object around (behind) the vehicle 100 based on information regarding the type of object around the vehicle 100 that is detected based on output data of the exterior camera 13 and positional information about a target around the vehicle 100.

The approach prediction section 333 predicts whether or not a mobile object detected by the mobile object detection section 331 will approach the vehicle 100 and arrive at a door of the vehicle 100 (in particular, whether or not, in a case where the door is open, the mobile object will arrive at the position at which the mobile object will collide with the door). In the present embodiment, the approach prediction section 333 predicts based on positional information (in particular, the position and the speed relative to the vehicle 100) about a mobile object detected by the mobile object detection section 331 whether or not the mobile object arrives at a door of the vehicle 100. The approach prediction section 333 predicts, for example, based on positional information about a mobile object detected by the mobile object detection section 331 whether or not the mobile object arrives at a door of the vehicle 100 within a predetermined reference time on the assumption that the mobile object moves while keeping the relative speed. The reference time may be a constant time defined in advance or a varying time depending on the value of any parameter such as the movement speed of the detected mobile object.

In a case where the approach prediction section 333 predicts that a mobile object arrives at a door of the vehicle 100, the warning section 334 basically warns an occupant of the vehicle 100. For example, in a case where a mobile object is predicted to arrive at a door of the vehicle 100 within the reference time, the warning section 334 warns an occupant of the vehicle 100 that the mobile object is predicted to arrive at the door.

Specifically, in such a case, the warning section 334 causes the display 16 to display the prediction of the arrival of the mobile object at the door and causes the speaker 17 to output sound indicating the prediction of the arrival.

In addition, in a case where the approach prediction section 333 predicts that a mobile object arrives at a door of the vehicle 100, the warning section 334 may restrict the door from being opened. Specifically, for example, in a case where a mobile object is predicted to arrive at a door of the vehicle 100, the warning section 334 controls the door actuator 21 of the door to prevent the door from being opened.

### Control in Case where Projection is Present

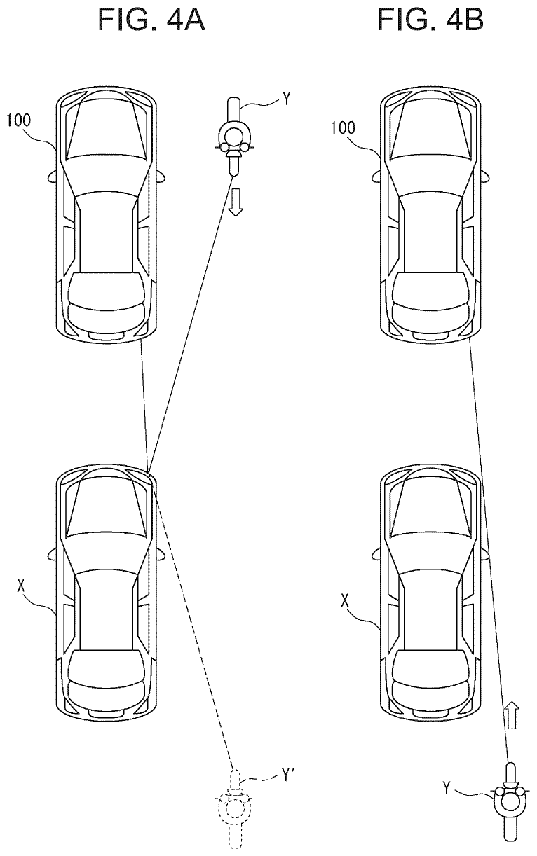

FIG. 4A and FIG. 4B are diagrams each illustrating an example of a case where another vehicle X is stopped behind the stopped vehicle 100 and a motorcycle Y is traveling around the vehicle 100. FIG. 4A illustrates a case where the motorcycle Y is traveling on a side of the vehicle 100 and FIG. 4B illustrates a case where the motorcycle Y is traveling behind and to the right of the vehicle 100.

Here, when radio waves radiated from the millimeter wave radars 11 are reflected by the front surface of the other vehicle X stopped behind the vehicle 100, it is not necessarily possible for the millimeter wave radars 11 to appropriately calculate positional information about the mobile object. In the example illustrated in FIG. 4A, radio waves radiated from the millimeter wave radars 11 (and reflection waves reflected by the motorcycle Y) are reflected by the front surface of the other vehicle X. The motorcycle Y may be therefore determined to be traveling behind the vehicle 100 in the direction where the motorcycle Y is approaching the vehicle 100 even though the motorcycle Y is traveling on the side of the vehicle 100 in the rearward direction apart from the vehicle 100. In the example illustrated in FIG. 4A, the motorcycle may be determined in error to be located at the position denoted by Y′ in the diagram and be traveling in the direction where the motorcycle Y is approaching the vehicle 100.

In view of this issue, in the present embodiment, even in a case where the approach prediction section 333 predicts that a mobile object will approach the vehicle 100 and arrive at a door of the vehicle 100, the warning section 334 refrains from warning an occupant when it is determined that a stationary object detected by the stationary object detection section 332 is located ahead of the mobile object. In the example illustrated in FIG. 4A, the vehicle X that is a stationary object detected by the stationary object detection section 332 is located ahead of the virtual motorcycle Y′ that is a mobile object detected by the mobile object detection section 331. The warning section 334 thus refrains from warning the occupant.

In the present embodiment, the warning section 334 neither warns the occupant nor controls the door actuator 21 to prevent the door from being opened in such a case. The warning section 334 may, however, refrain from warning the occupant in another method. For example, in the present embodiment, the warning section 334 causes the display 16 to display the prediction of the arrival of a mobile object at a door and causes the speaker 17 to output sound indicating the prediction of the arrival. However, in a case where it is detected that a stationary object is located ahead of the mobile object, the warning section 334 may carry out one of them alone. In addition, in a case where it is detected that the stationary object is located ahead of the mobile object, the warning section 334 may lower the volume of sound to be output from the speaker 17 in comparison with the volume of sound to be output in a case where it is not detected that the stationary object is located ahead of the mobile object.

Meanwhile, in a case where a projection (e.g., an outer mirror of a vehicle, a loaded object projecting sideward from a vehicle, or the like) of a stationary object is located ahead of a mobile object as illustrated in FIG. 4B, the warning section 334 determines that the stationary object detected by the stationary object detection section 332 is located ahead of the mobile object. However, in the example illustrated in FIG. 4B, the motorcycle Y that is a mobile object is actually present behind and to the right of the vehicle 100 and the presence of the motorcycle Y is not detected in error.

Accordingly, in the present embodiment, in a case where the approach prediction section 333 predicts that a mobile object will approach the vehicle 100 and arrive at a door of the vehicle 100, the warning section 334 does not refrain from warning an occupant when it is determined that a stationary object detected by the stationary object detection section 332 is located ahead of the mobile object, but the stationary object located ahead of the mobile object is a projection projecting from the other vehicle X in the vehicle width direction. In the example illustrated in FIG. 4B, the stationary object detected to be located ahead of the motorcycle Y is a projection (an outer mirror of the other vehicle X) of the other vehicle X and the warning section 334 does not thus refrain from warning an occupant. The warning section 334 thus causes the display 16 to display the prediction of the arrival of the mobile object at the door and causes the speaker 17 to output sound indicating the prediction of the arrival. In addition, the warning section 334 controls the door actuator 21 to prevent the door from being opened.

As a result, in a case where the projection of the stationary object is located ahead of the mobile object that is actually present as illustrated in FIG. 4B, the mobile object is prevented from being determined to be detected in error, avoiding an occupant not being warned. Thus, issuance of a notification to an occupant is restrained from being prevented in error.

### Flow of Warning Processing

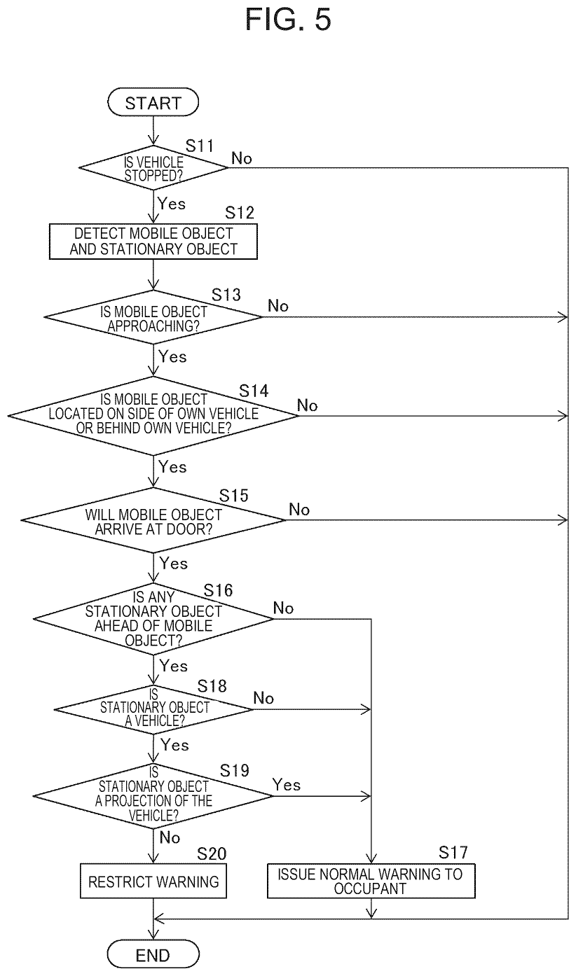

Next, the flow of warning processing of warning an occupant of the vehicle 100 will be described with reference to FIG. 5. FIG. 5 is a flowchart illustrating the flow of the warning processing. The warning processing illustrated in FIG. 5 is executed by the processor 33 of the ECU 30.

When the warning processing starts, the warning section 334 determines whether or not the vehicle 100 is stopped (step S11). It is determined based on output data of the vehicle speed sensor 14 whether or not the vehicle 100 is stopped. In a case where the vehicle 100 is not stopped, no door of the vehicle 100 is opened. It is therefore unnecessary to warn an occupant even in a case where a mobile object arrives at the door of the vehicle 100. Thus, in a case where it is determined in step S11 that the vehicle 100 is not stopped, the warning processing ends.

In contrast, in a case where it is determined in step S11 that the vehicle 100 is stopped, the mobile object detection section 331 detects a mobile object behind the vehicle 100 and the stationary object detection section 332 detects a stationary object behind the vehicle 100 (step S12). In the present embodiment, the mobile object detection section 331 and the stationary object detection section 332 respectively detect a mobile object and a stationary object based on pieces of output data of the millimeter wave radars 11, the ultrasonic wave sensors 12, and the exterior camera 13. In the present embodiment, the mobile object detection section 331 detects the position and the speed of a mobile object around the vehicle 100 relative to the vehicle 100. In addition, the stationary object detection section 332 detects the position of a stationary object around the vehicle 100 relative to the vehicle 100, the shape of the stationary object, and the type of stationary object. In addition, the stationary object detection section 332 detects a projection of a stationary object based on output data of the exterior camera 13. In the present embodiment, the stationary object detection section 332 detects the shape of a stationary object (such as another vehicle) located behind the vehicle 100 based on output data of the exterior camera 13 and detects the position of a projection of the stationary object based on the shape of the stationary object. Alternatively, the stationary object detection section 332 may detect the position of the projection of the stationary object based on the shape of the stationary object detected based on output data of the exterior camera 13 and positional information about the stationary object detected based on pieces of output data of the millimeter wave radars 11 or the ultrasonic wave sensors 12.

Subsequently, the approach prediction section 333 determines whether or not the mobile object detected in step S12 is approaching the vehicle 100 (step S13). In the present embodiment, the approach prediction section 333 determines based on the speed of the mobile object relative to the vehicle 100 whether or not the mobile object is approaching the vehicle 100. In a case where it is determined in step S13 that the mobile object is not approaching the vehicle 100, the warning processing ends.

In a case where it is determined in step S13 that the mobile object is approaching the vehicle 100, the approach prediction section 333 determines whether or not the mobile object determined in step S13 to be approaching the vehicle 100 is located on a side of the vehicle 100 or behind the vehicle 100 (step S14). In the present embodiment, the approach prediction section 333 determines based on the position of the mobile object relative to the vehicle 100 whether or not the mobile object is located on a side of the vehicle 100 or behind the vehicle 100. In a case where it is determined in step S14 that the mobile object is not located on a side of the vehicle 100 or behind the vehicle 100, the warning processing ends.

In a case where it is determined in step S14 that the mobile object is located on a side of the vehicle 100 or behind the vehicle 100, the approach prediction section 333 determines whether or not the mobile object determined in step S14 to be located on a side of the vehicle 100 or behind the vehicle 100 is predicted to arrive at a door of the vehicle 100 (step S15). In the present embodiment, the approach prediction section 333 determines based on the position and the speed of the mobile object relative to the vehicle 100 whether or not the mobile object is predicted to arrive at a door of the vehicle 100. In a case where it is determined in step S15 that the mobile object is not predicted to arrive at a door of the vehicle 100, the warning processing ends.

In a case where it is determined in step S15 that the mobile object is predicted to arrive at a door of the vehicle 100, the warning section 334 determines whether or not the stationary object detected by the stationary object detection section 332 is located ahead of the mobile object detected in step S12 (step S16). In the present embodiment, the warning section 334 determines based on the position of the stationary object relative to the vehicle 100 and the shape of the stationary object whether or not the stationary object is located ahead of the mobile object.

In a case where it is determined in step S16 that the stationary object is not located ahead of the mobile object, the warning section 334 issues, to an occupant of the vehicle 100, a normal warning indicating that the mobile object is predicted to arrive at a door (step S17). Specifically, the warning section 334 causes the display 16 to display the prediction of the arrival of the mobile object at the door and causes the speaker 17 to output sound indicating the prediction of the arrival.

In contrast, in a case where it is determined in step S16 that the stationary object is located ahead of the mobile object, the warning section 334 determines whether or not the stationary object determined in step S16 to be located ahead of the mobile object is another vehicle (step S18). In the present embodiment, the warning section 334 determines based on the type of stationary object detected by the stationary object detection section 332 whether or not the stationary object is another vehicle. In a case where it is determined in step S18 that the stationary object is not another vehicle, the warning section 334 issues a normal warning (step S17).

In a case where it is determined in step S18 that the stationary object is a vehicle, the warning section 334 determines whether or not the stationary object located ahead of the mobile object is a projection of the stationary object determined in step S16 to be another vehicle (step S19). In the present embodiment, the warning section 334 determines whether or not the position of a projection of the stationary object detected by the stationary object detection section 332 is located ahead of the position of the mobile object detected by the mobile object detection section 331. Additionally, in the present embodiment, in a case where a projection of a stationary object and a portion of the stationary object that is not the projection are both located ahead of a mobile object, the warning section 334 determines that the stationary object located ahead of the mobile object includes a portion that is not the projection of the stationary object and is not thus the projection of the stationary object.

In a case where it is determined in step S19 that the stationary object located ahead of the mobile object is not a projection of another vehicle, the warning section 334 issues a normal warning (step S17). In contrast, in a case where it is determined in step S19 that the stationary object located ahead of the mobile object is a projection of another vehicle, the warning section 334 restricts a warning to an occupant of the vehicle 100 (step S20).

### Modification Examples

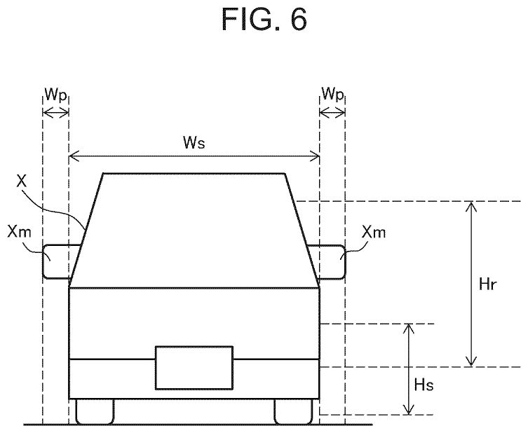

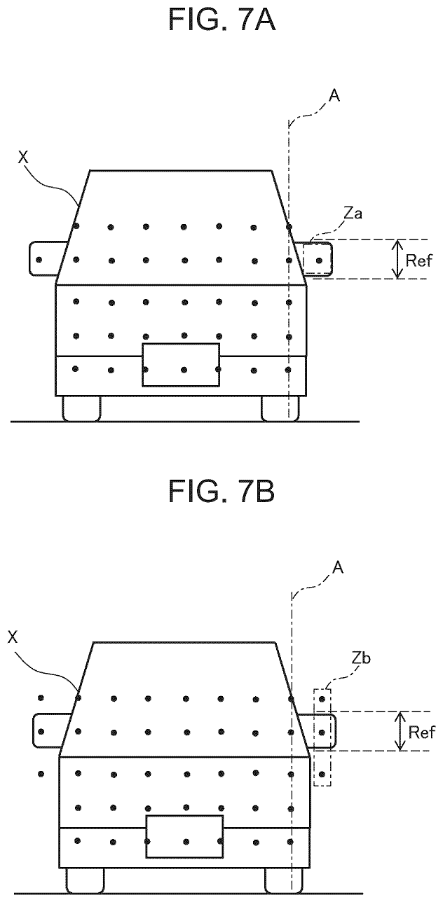

Next, modification examples will be described with reference to FIG. 6, FIG. 7A, and FIG. 7B. In one modification example, the stationary object detection section 332 detects a stationary object based on pieces of output data of the millimeter wave radars 11 and the ultrasonic wave sensors 12.

FIG. 6 is a diagram illustrating the other vehicle X located behind the vehicle 100. As described above, the measurement range of each of the ultrasonic wave sensors 12 is located lower than the measurement range of each of the millimeter wave radars 11. This allows the millimeter wave radar 11 to measure the distance or the like in a region Hr in the diagram as illustrated in FIG. 6. Meanwhile, the ultrasonic wave sensor 12 measures the distance or the like in a region Hs lower than the region Hr. As a result, the millimeter wave radar 11 carries out measurement in the height region in which a projection (outer mirror) Xm is located. Meanwhile, the ultrasonic wave sensor 12 does not carry out measurement in the height region in which the projection (outer mirror) Xm is located.

Accordingly, in the present modification example, in a case where the shape of the other vehicle X detected by the millimeter wave radars 11 projects more in the vehicle width direction of the other vehicle X than the shape of the other vehicle X (stationary object) detected by the ultrasonic wave sensors 12, the stationary object detection section 332 detects the projecting portion as a projection. In the example illustrated in FIG. 6, the stationary object detection section 332 thus detects regions Wp in the vehicle width direction of the other vehicle X as regions in each of which the projection Xm of the other vehicle X is located. Meanwhile, the stationary object detection section 332 detects a region Ws in the vehicle width direction of the other vehicle X as a region in which the projection Xm of the other vehicle X is not located. This allows the stationary object detection section 332 to detect the projection without using output data of the exterior camera 13.

Next, another modification example will be described with reference to FIG. 7A and FIG. 7B. In the present modification example, the stationary object detection section 332 detects a stationary object based on output data of laser radars (LiDARs) used instead of the millimeter wave radars 11. In the present modification example, the laser radars radiate laser light at a plurality of different angles in the vertical direction and the horizontal direction and measure the distances to a target at the respective angles based on the reflection light of the laser light. The laser radars thus measure the distances to the target at a plurality of measurement points in the vertical direction and the horizontal direction. FIG. 7A and FIG. 7B are diagrams each similar to FIG. 6 and each illustrate the other vehicle X located behind the vehicle 100. Black dots in the diagrams represent measurement points at which it is detected that an object is located around the front surface of the vehicle X among the measurement points at which the distances are measured by the radars.

In the present modification example, in a case where a target standing still to have substantially the same distance is measured at a large number of measurement points arranged in the vertical direction, that is, in a case where it is detected that the vertical width of a target is greater than or equal to a certain width, the stationary object detection section 332 determines that the other vehicle X (stationary object) is located at the position. The stationary object detection section 332 then estimates the position (A in each of the diagrams) of a column of measurement points the closest to an end in the horizontal direction among the columns in which the target is detected at a large number of measurement points in the vertical direction as the position of an end of the other vehicle X in the width direction of the other vehicle X. Additionally, for example, in a case where it is possible to detect the position of a tire of the other vehicle X based on the point group data of the measurement points of the radars, the stationary object detection section 332 may estimate the position of the outside of the tire as the position of an end of the other vehicle X in the width direction of the other vehicle X.

In addition, in a case where a target is detected at measurement points outside the end of the other vehicle X thus calculated in the width direction of the other vehicle X, the stationary object detection section 332 determines that a projection (such as an outer mirror or a loaded object) of the other vehicle X is located at the positions of the measurement points. In a case where more measurement points at which a target is detected are arranged in the vertical direction than a certain number of measurement points, that is, in a case where the vertical width of a target is greater than a predetermined reference width, the stationary object detection section 332 does not, however, determine that a projection is located even in such a case. Thus, in the example illustrated in FIG. 7B, the vertical width of the target is greater than a reference width Ref and it is therefore determined that no projection is present in a region Zb in the diagram.

In contrast, in a case where the measurement points less than or equal to a certain number of measurement points at which a target is detected are arranged in the vertical direction, that is, in a case where the vertical width of a target is less than or equal to the predetermined reference width, the stationary object detection section 332 determines that a projection is located at the positions of the measurement points. The stationary object detection section 332 thus carries out detection on the assumption that the radars detect another object and a projection of the object is located at a portion of the object detected to have a vertical width less than or equal to a predetermined reference width on a side of the object. In the example illustrated in FIG. 7A, the vertical width of the target is less than or equal to the reference width Ref and it is thus determined that the projection is located in a region Za in the diagram. This allows the stationary object detection section 332 to detect the projection without using output data of the ultrasonic wave sensors 12 in addition to the exterior camera 13.

The preferred embodiment according to the present disclosure has been described so far, but the present disclosure is not limited to the embodiment. It is possible to make various alternations and changes within the description of the claims.

What is claimed is:

1. A warning apparatus configured to warn an occupant of a vehicle, the warning apparatus comprising:
a mobile object detection section configured to detect a mobile object behind the vehicle based on output data of a sensor;
a stationary object detection section configured to detect a stationary object behind the vehicle based on output data of a sensor; and
a warning section configured to warn the occupant of the vehicle in a case where the mobile object is predicted to approach the vehicle and arrive at a door of the vehicle, wherein
the warning section is configured to refrain from issuing the warning when the stationary object is detected to be located ahead of the mobile object even in the case where the mobile object is predicted to approach the vehicle and arrive at the door of the vehicle, and is configured not to refrain from issuing the warning when the stationary object is another vehicle that includes a projection that projects in a vehicle width direction even when the stationary object is detected to be located ahead of the mobile object.

2. The warning apparatus according to claim 1, wherein the stationary object detection section is configured to detect the projection of the stationary object based on output data of an exterior camera configured to image a region behind the vehicle.

3. The warning apparatus according to claim 1, wherein:
the stationary object detection section is configured to detect the stationary object based on pieces of output data of a radar and an ultrasonic wave sensor each configured to detect a distance to an object behind the vehicle;
the ultrasonic wave sensor is configured to detect the distance to the object behind the vehicle in a lower region in a vertical direction than the radar; and
the stationary object detection section is configured to detect, in a case where a shape of the vehicle detected by the radar projects more in the vehicle width direction of the vehicle than a shape of the vehicle detected by the ultrasonic wave sensor, a projecting portion as the projection.

4. The warning apparatus according to claim 1, wherein:
the stationary object detection section is configured to detect the stationary object based on output data of a radar configured to detect a distance to an object behind the vehicle; and
the stationary object detection section is configured to carry out detection on an assumption that the radar detects another object and a projection of the object is located at a portion of the object detected to have a vertical width less than or equal to a predetermined width on a side of the object.

5. A warning method for warning an occupant of a vehicle, the warning method comprising:
detecting a mobile object behind the vehicle based on output data of a sensor;
detecting a stationary object behind the vehicle based on output data of a sensor; and
warning the occupant of the vehicle in a case where the mobile object is predicted to approach the vehicle and arrive at a door of the vehicle, wherein
the warning is prevented from being issued when the stationary object is detected to be located ahead of the mobile object even in the case where the mobile object is predicted to approach the vehicle and arrive at the door of the vehicle, and the warning is not prevented from being issued when the stationary object is another vehicle that includes a projection that projects in a vehicle width direction even when the stationary object is detected to be located ahead of the mobile object.
